(19) United States
(12) Patent Application Publication
(10) Pub. No.: US 2004/0021259 A1
(43) Pub. Date: Feb. 5, 2004

(54) Anti-vibration mount and production method for same

(76) Inventors: Herve Visage, Chateaudun (FR); Daniel Le Guillant, Chateaudun (FR); Arnaud Camus, Saint Pellerin (FR); Herve Costalunga, Nottonville (FR)

Correspondence Address: MCCRACKEN AND FRANK, 200 W. ADAMS STREET, SUITE 2150, CHICAGO, IL, 60606, US

(21) Appl. No.: 10/333,711

(22) PCT Filed: May 24, 2002
(86) PCT No.: PCT/FR02/01760

(30) Foreign Application Priority Data
May 25, 2001 (FR) 01/06884

(51) Int. Cl. F16M 7/00; F16F 13/00

(52) U.S. Cl. 267/140.13

(57) ABSTRACT

The invention relates to an anti-vibration mount comprising two rigid frames (2, 3), a rigid insert (4), which is fixed to the first frame (2), and an elastomer body (6) which at least partially overmoulds the insert (4) and which connects said insert to the second frame (3). The insert (4) is positioned in two lateral guides (14) which extend perpendicularly to the main direction of vibration (Z). Said insert (4) and said lateral guides (14) are shaped in such a way that the insert (4) is wedged in the lateral guides (14), without any clearance in the main direction of vibration. A deformed end area prevents the insert (4) from coming out of the guides.

The present invention relates to antivibration supports, and to methods of manufacturing such supports.

More particularly, the invention relates to an antivibration support for interposing between first and second rigid elements in order to damp vibration between said two elements, at least in a main vibration direction, the support comprising:

first and second rigid strength members for connecting respectively to the first and second rigid elements that are to be connected together, the first strength member having two lateral guides extending longitudinally substantially in a first direction in a plane perpendicular to the main vibration direction, each of these lateral guides itself including at least one bearing surface also extending parallel to the longitudinal direction of the lateral guide to which it belongs;

a rigid insert fixed to the first strength member by said insert being engaged between the two lateral guides substantially along the first direction perpendicular to the main vibration direction, at least one element selected from the insert and the first strength member presenting at least one abutment zone that is plastically deformed to prevent the insert from separating from the lateral guides; and

an elastomer body overmolded on at least part of the insert and connecting said insert to the second strength member.

Document U.S. Pat. No. 5,636,826 describes an example of an antivibration support of this type. This type of antivibration support suffers from the drawback of presenting play between the insert and the first strength member, in particular in the main vibration direction and/or in the direction that is perpendicular both to the main vibration direction and to the first direction. This play comes from the fact that in order to slide the insert between the lateral guides, the dimensions of the insert must be slightly smaller than the distances between the points of the lateral guides between which the insert is to be engaged. Otherwise, the insert must be engaged between the lateral guides by force, thereby complicating the process of assembling the insert on the first strength member and requiring the parts for assembly to be of dimensions that are capable of withstanding the forces associated with the stresses due to forced insertion of the insert into the lateral guides.

A particular object of the present invention is to mitigate those drawbacks.

To this end, according to the invention, an antivibration support of the kind in question is characterized by the fact that at least two bearing surfaces form a wedge by virtue of said two bearing surfaces approaching each other in at least one direction selected from the main direction of vibration and the second direction.

By means of these dispositions, the insert can be assembled to the first strength member by wedging, without the process of assembling one with the other requiring tools suitable for delivering large amounts of force, and without play once the insert is in abutment against the bearing surfaces of the lateral guides, and without it being necessary to dimension the insert and/or the first strength member so as to be capable of withstanding relatively high forces. This has the particular advantage of providing a saving in weight.

Furthermore, assembly the insert with the first strength member does not require a threaded pin or a nut, thereby reducing the weight and the cost of the antivibration support, and simplifying assembly thereof. In particular, the operations of slidably engaging the insert in the lateral guides of the first strength member and then of creating the abutment zone by plastic deformation, which zone subsequently holds the insert in position in said lateral guides, can be performed in a manner that is completely automatic.

Finally, the way the insert is engaged in two lateral guides also makes it possible to reduce stress concentration in the insert while it is in operation, and thus makes it possible to reduce the weight and the size of the insert.

In preferred embodiments of the invention, recourse may optionally also be made to one or more of the following dispositions:

the insert is engaged in two parallel lateral guides extending in the first longitudinal direction perpendicular to the main vibration direction, the insert and said lateral guides being shaped in such a manner that the insert is wedged in said lateral guides without play in the main vibration direction, each of the lateral guides having a first end and a second end, the first end being open in the first direction, each guide having free height measured parallel to the main vibration direction which decreases going from the first end to the second end, and the insert presenting first and second portions at said first and second ends;

the first portion of the insert is a raised rim perpendicular to the longitudinal direction of the lateral guides, the second portion being an edge opposite said rim;

the insert comes into abutment against the second ends of the lateral guides;

each of the lateral guides has first and second ends, the first ends of the two lateral guides being spaced apart by a distance greater than the distance between the second ends of the two lateral guides;

the insert and the lateral guides are shaped in such a manner that the insert is wedged in the lateral guides without play in a second direction perpendicular to the first direction and to the main vibration direction;

the insert has two edges, each of which extends parallel to a respective bearing surface when the insert is in place on the first strength member;

the abutment zone comprises a punching made in the first strength member and forming a projection of material at the first end of at least one of the lateral guides;

each lateral guide has a lip covering the insert in part, and the abutment zone comprises at least one pressed-down zone of the lip of the lateral guide pressed against the insert;

the abutment zone comprises at least one folded-down portion of the insert, said portion being folded down against an edge belonging to the first strength member;

the support has at least one layer of elastomer interposed between the insert and the first strength member; and

the insert is a stamped metal sheet having a central portion that is substantially frustoconical on which the elastomer body is overmolded.

In another aspect, the invention provides a method of manufacturing an antivibration support comprising one or more of the characteristics specified above, with the method comprising the following steps:

molding the elastomer body between the insert and the second strength member;

after unmolding, engaging the insert in the lateral guides until said insert becomes wedged in the lateral guides; and

making said abutment to prevent the insert from moving relative to said first strength member, thereby preventing said insert from escaping from the lateral guides.

Other characteristics and advantages of the invention appear from the following description of various embodiments given as non-limiting examples and described with reference to the accompanying drawings.

In the drawings:

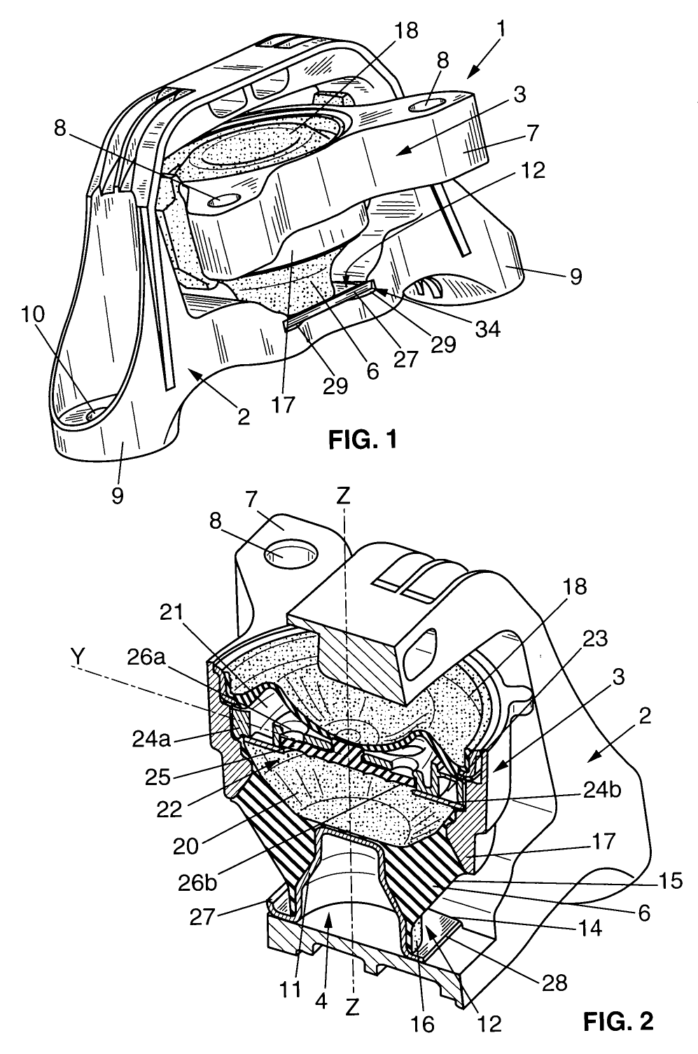

FIG. 1 is a perspective view of the antivibration support;

FIG. 2 is a half-view in perspective of the FIG. 1 support, the section plane being substantially parallel to the main direction of vibration;

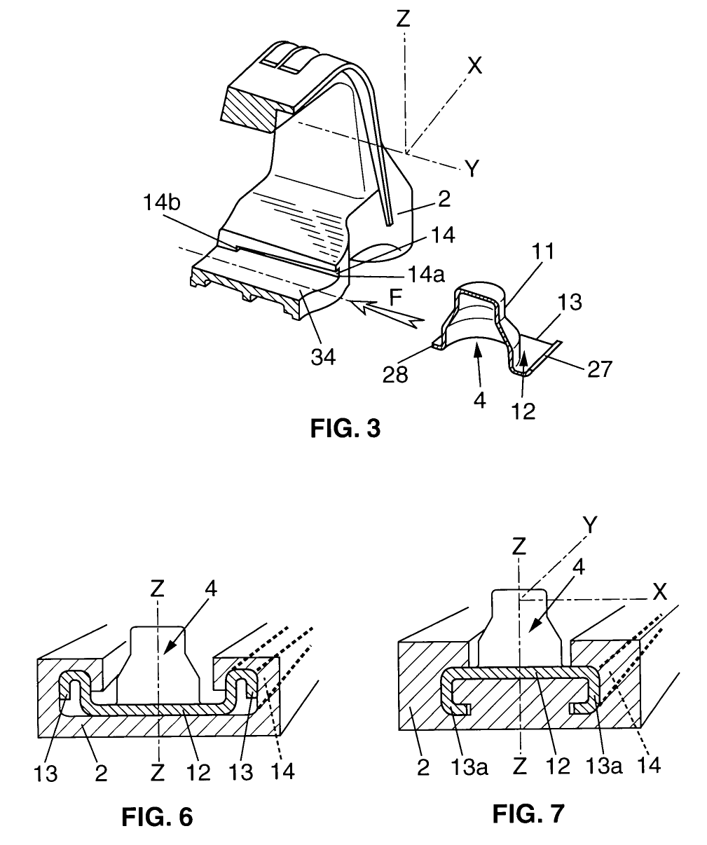

FIG. 3 is a perspective view showing the process whereby the main components of the FIG. 1 antivibration support are assembled, i.e. whereby the insert is assembled by being slid into the first strength member;

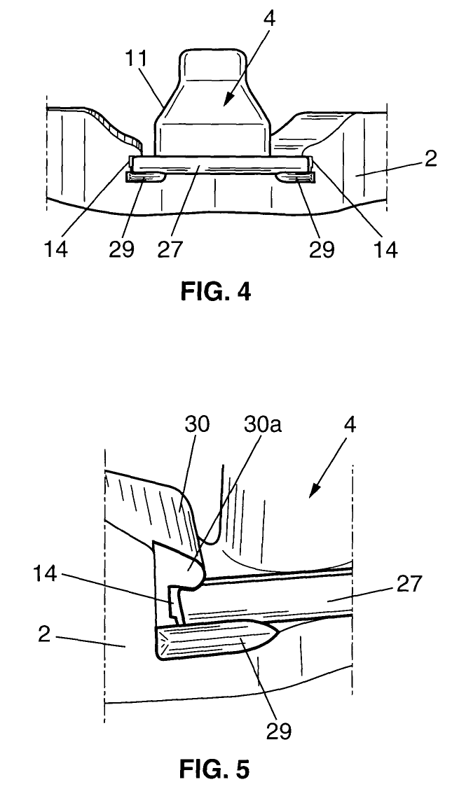

FIG. 4 is a perspective view of the FIG. 1 antivibration support, showing the abutment zone between the insert and the first strength member;

FIG. 5 is a perspective of a larger scale of the abutment zone of FIG. 4;

FIGS. 6 and 7 are perspective views showing various embodiments of the lateral guides;

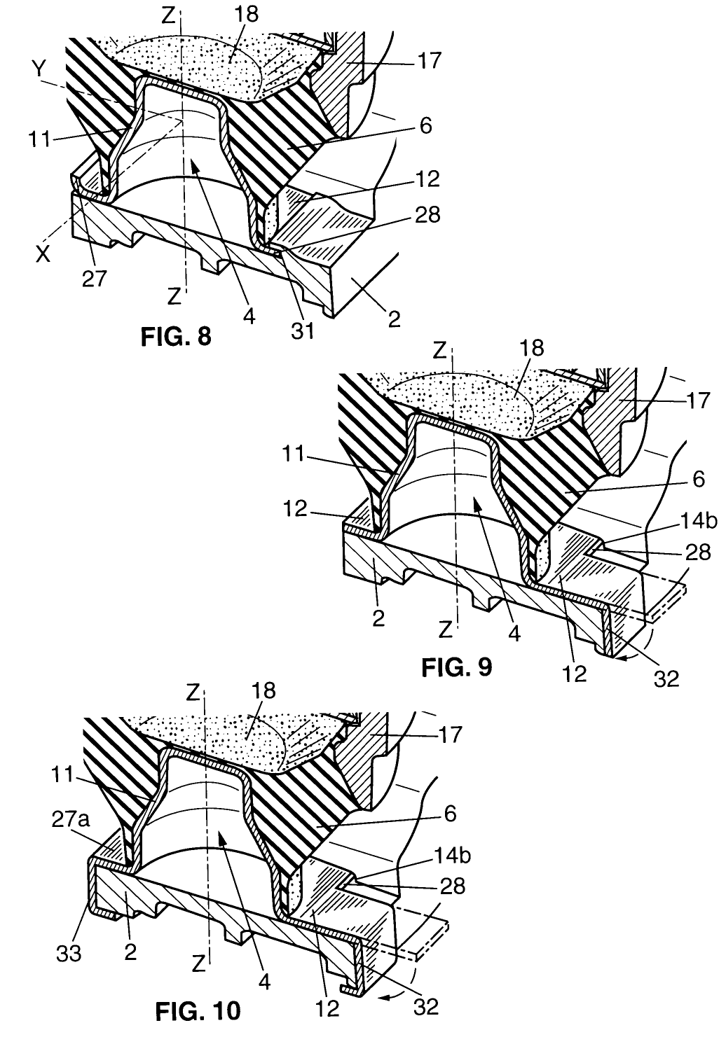

FIGS. 8, 9, 10, and 11 are views similar to FIG. 2 showing various embodiments of the abutment zone between the insert and the first strength member; and

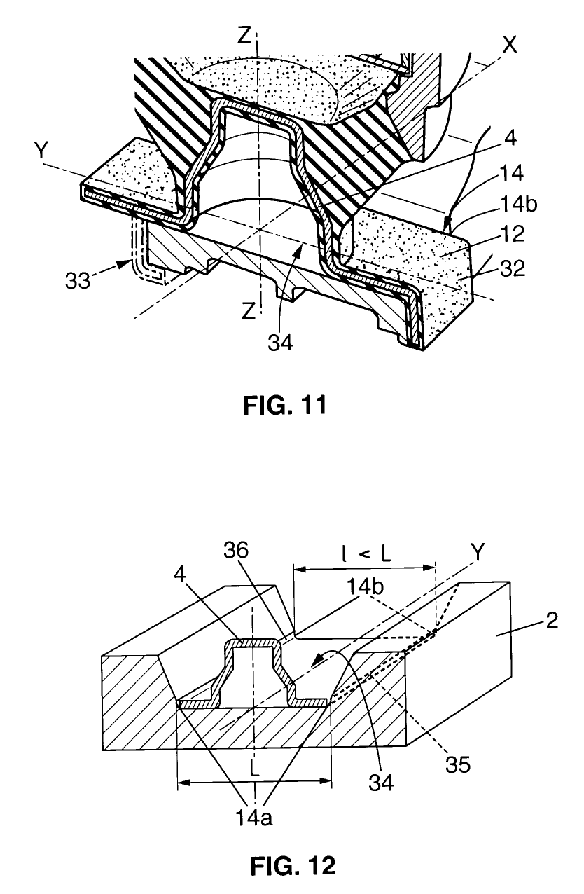

FIG. 12 is diagrammatic perspective view of an embodiment of lateral guides corresponding to the support shown in FIG. 11.

In the various figures, the same references designate elements that are identical or similar.

With reference to FIGS. 1 and 2, the antivibration support 1 of the invention comprises:

a first metal strength member 2 that is made as an aluminum casting, for example, and that is of generally annular shape, this first strength member extending substantially in a vertical plane and being centered on a horizontal axis Y in the example under consideration;

a second metal strength member 3 which is annular in shape in the example shown, being centered on an axis Z that may be, in particular, vertical, said axis Z constituting the main axis of the vibration to which the antivibration support 1 is subjected, said strength member 3 being made in particular as an aluminum casting and possessing a substantially circular section centered on the vertical axis Z;

a metal insert 4 that is generally frustoconical in shape, centered on the axis Z, and secured to the first strength member 2; and

an elastomer body 6 connecting together the insert 4 and the second strength member 3, which body is overmolded and bonded onto the insert 4 and the second strength member 3, e.g. by vulcanization.

By way of example, the second strength member 3 is designed to be secured via lugs 7 situated at the periphery of said strength member to a vehicle engine (not shown) by means of fasteners such as screws passing through orifices 8 formed in the lugs 7.

The first strength member 2 is then designed to be secured to the structure (not shown) of a vehicle via connection elements such as, for example, projecting tabs 9 integrally formed with the first strength member 2, these tabs 9 being provided with orifices 10 for passing fastener devices (screws, pins, or the like).

In a variant, the first strength member 2 may optionally form an integral portion of the structure of the vehicle, or more generally of one of the two vehicle elements connected together by the antivibration support 1.

With reference to FIG. 2, the insert 4 may advantageously be made of stamped sheet metal. The insert comprises firstly a hollow frustoconical portion 11 centered on the axis Z and having the elastomer body 6 bonded thereon via its outside wall, and secondly a base plate 12 formed integrally with the frustoconical portion 11, and extending substantially perpendicularly to the main vibration axis Z.

The elastomer body when seen in section in a vertical plane containing the axis Z (FIG. 2) presents a side wall 15 that is substantially frustoconical, being circularly symmetrical about the vertical axis Z. This side wall 15 extends between a top 16 secured to the insert 4 and an annular base 17 secured to the second strength member 3.

The inside wall of the second strength member 3 is connected, in particular by crimping, to the periphery of bellows 18 made of thin and flexible elastomer material co-operating with the elastomer body 6 and the second strength member 3 to define a sealed housing.

This housing is subdivided by a partition 22 into two hydraulic chambers 20 and 21 that are filled with liquid, comprising a working chamber 20 that is conical in shape being defined by the elastomer body 6, and a compensation chamber 21 that is defined by the bellows 18, these two chambers 20 and 21 communicating with each other via a constricted passage 23 formed in the partition 22 between a shell 24a constituted by a light alloy casting and a sheet metal closure plate 24b which together constitute the partition 22.

Furthermore, the partition 22 may conventionally include an elastomer decoupling flap 25 mounted with a small amount of clearance between the shell 24a and the closure plate 24b, the two faces of the flap being in communication respectively with the working chamber 20 via at least one opening 26b through the plate 24b, and with the compensation chamber via a grid 26a made in the shell 24a.

The flap 25 is particularly effective in absorbing vibration of relatively high frequency and low amplitude between the first and second strength members 2 and 3, while the constricted passage 23 is effective for damping vibration of low frequency (e.g. below 20 hertz (Hz)) and large amplitude (e.g. greater than 1 millimeter (mm)).

As shown in FIGS. 1 and 2, two opposite edges of the base plate 12 of the insert 4 are engaged in two slots extending along the axis Y and open facing each other looking towards the base plate 12. Each of these slots made in the first strength member extends between first and second ends 14a and 14b (see FIG. 3), the first end 14a being open parallel to the longitudinal direction Y, and the second end 14b being closed in the example shown.

Furthermore, each of the slots 14 presents free height measured parallel to the main direction of vibration which decreases going from the first end towards the second end.

The way in which the two strength members 2 and 3 are assembled together is shown in FIG. 3, with this being done by causing the side walls 13 of the base plate 12 to co-operate with the lateral guides 14, these guides 14 (only one of which is shown in FIG. 3) extending perpendicularly to the main direction of vibration. The base plate 12 of the insert 4 is engaged like a drawer by sliding movement in the direction of arrow F between the bottom and top bearing surfaces of the lateral guides 14 of the housing 34 until said base plate 12 becomes wedged in the lateral guides 14.

This wedging is obtained by the base plate 12 being clamped vertically in the guides 14:

firstly at the first end 14a of the guides into which a rim 27 formed by a raised rear edge of the base plate 12 is engaged by force; and

secondly at the second end 14b of the guides into which the front edge 28 of the base plate 12 is engaged by force, said front edge 28 extending parallel to the rim 27.

This retention by wedging prevents the insert 4 from vibrating mainly along the axis Z, while in the embodiment of the antivibration support shown in FIGS. 1 and 2, the insert is prevented from moving in translation along the sliding direction Y:

firstly by the front edge 28 of the base plate 12 coming into abutment against the closed ends 14b of the guides 14; and

secondly by abutment zones 29 that can clearly be seen in FIG. 4 that are obtained by plastically deforming the first strength member 2, in particular by punching the first ends 14a of the lateral guides 14, these abutment zones 29 co-operating with the rim 27 to prevent it from escaping from the ends 14a.

Furthermore, the base plate 12 is prevented from moving in the horizontal direction X perpendicular to the axis Y because it is engaged in the guides 14 without any clearance in said direction.

As shown in FIG. 5, in order to further improve the retention of the insert 4 in its housing 27, it is also possible to plastically deform the lip 30 of the first strength member when it overlies the lateral guides 14, this lip being pressed down against the base plate 12 over at least a pressed-down zone 30a e.g. situated at the first end 14a of each guide 14 (the pressed-down portion 30a locally deforms the rim 27 in the example shown).

FIGS. 6 and 7 show various profiles that can be given in other embodiments of the support of the present invention for the lateral guides 14 made in the first strength member 2 and for the complementary side walls 13 of the base plate 12 of the insert 4, respectively. In FIG. 6, the side walls 13 of the base plate 12 have a series of U-shaped folds that are open downwards along the axis Z to provide channel sections, and in the example shown in FIG. 7, the side walls 13a of the base plate 12 form U-shaped open channel sections facing each other along the axis X. In these two embodiments, the lateral guides 14 present profiles that converge going from their first ends 14a towards the second ends 14b, as described above.

The antivibration supports 1 shown in FIGS. 8, 9, 10, and 11 are similar to those described above, but differ merely in the various ways in which fixing is provided between the base plate 12 of the insert 4 and the housing 27 in the first strength member 2;

in FIG. 8, the front edge 28 of the base plate 12 is engaged in a slot 31 extending along the axis X, with the insert 4 otherwise being secured to the first strength member 2 identically to the manner described above;

in FIG. 9, the insert 4 is prevented from moving in translation in the housing 27 of the first strength member by a folded-down tab 32 of the base plate 12 which is folded down and possibly also crimped against the bottom portion of the first strength member 2, this folded-down tab extends the front edge 28 of the base plate 12, which front edge comes into abutment against the second end 14b of the guides 14 as in the preceding examples;

in FIG. 10, the insert 4 is prevented from moving by holding down two tabs 32 and 33 of the insert 4, said tabs being folded down respectively against two opposite edges of the bottom portion of the first strength member 2, the folded-down tabs extending the front and rear edges 28 and 27a of the base plate 12; and

in FIG. 11, the plate 12 of the insert 4 passes right through the housing 34 in the direction Y, it being prevented from moving in translation in said direction by the fact that the lateral guides 14 are shaped so that the insert 4 is wedged between respective lateral bearing surfaces of the lateral guides 14 without clearance in the direction X; this can be achieved by a disposition in which each of the lateral guides 14 has a first end 14a and a second end 14b with the first ends 14a of the two lateral guides 14b being spaced apart by a distance L that is greater than the distance l between the second ends 14b of the two lateral guides 14 (see FIG. 12), the edges 35 of the base plate 12 in the direction Y, or the side walls 13 likewise being of spacing that varies equivalent to that between the respective lateral bearing surfaces of the lateral guides 14; in this way, the insert 4 can be engaged in the direction Y on the base plate 12 until the edges 35 or the side walls 13 come into abutment inside the lateral guides 14, thus eliminating any play in the directions X and Y.

In the embodiments of FIGS. 9 and 10, the side edges of the base plate 12 are, as before, wedged in the guides 14 at least at the second ends 14b of said guides, because of the converging shape of said guides. The rim 27 of the base plate may then optionally be omitted, as can the above-mentioned pressed-down zones 30a of the lips 30. In contrast, the punchings 29 can be eliminated since the tabs 32 then constitute plastically-deformed abutment zones and prevent the insert 4 from escaping from the guides 14.

In the embodiment of FIG. 11, the base plate 12 is wedged in the Y direction firstly by the converging shape of its edges 35 and bearing surfaces 36 of the lateral guides 14, and secondly by the folded-down portions 32.

In yet another variant embodiment (shown in FIG. 11) the base plate 12 may be coated in a layer of rubber on its surfaces that come into contact with the first strength member 2, thus restricting and damping play, particularly in the direction Z.

It will be understood from the above that the way in which the base plate 12 of the insert 4 (and thus the entire second strength member 3) is fixed to the first strength member 2 without using any pin, screw, or similar fastener device makes it possible to simplify the process of manufacturing the antivibration support 1.

In particular, when assembling the elastomer body 6, the insert 4 and the second strength member 3 are placed in a mold, while omitting the first strength member 2 and any fastener device (screw, pin, . . . ), thus possibly enabling a larger number of mold cavities to be provided in a single mold given the relatively small size of the part that is molded in this way.

1/ An antivibration support (1) for interposing between first and second rigid elements in order to damp vibration between said two elements, at least in a main vibration direction (Z), the support comprising:
first and second rigid strength members (2, 3) for connecting respectively to the first and second rigid elements that are to be connected together, the first strength member (2) having two lateral guides (14) extending longitudinally substantially in a first direction (Y) in a plane perpendicular to the main vibration direction (Z), each of these lateral guides (14) itself including at least one bearing surface also extending parallel to the longitudinal direction of the lateral guide to which it belongs;
a rigid insert (4) fixed to the first strength member (2) by said insert (4) being engaged between the two lateral guides (14) substantially along the first direction (Y) perpendicular to the main vibration direction (Z), at least one element selected from the insert (4) and the first strength member (2) presenting at least one abutment zone (29, 30, 32, 33) that is plastically deformed to prevent the insert (14) from separating from the lateral guides (14); and
an elastomer body (6) overmolded on at least part of the insert (4) and connecting said insert (4) to the second strength member (2);
the support being characterized by the fact that at least two bearing surfaces form a wedge by said two bearing surfaces approaching each other in at least one direction (X; Z) perpendicular to the longitudinal direction of the lateral guides.

2/ An antivibration support according to claim 1, in which the insert (4) is engaged in two parallel lateral guides (14) extending in the first longitudinal direction (Y) perpendicular to the main vibration direction (Z), the insert (4) and said lateral guides (14) being shaped in such a manner that the insert (4) is wedged in said lateral guides (14) without play in the main vibration direction, each of the lateral guides (14) having a first end and a second end (14a, 14b), the first end (14a) being open in the first direction (Y), each guide (14) having free height measured parallel to the main vibration direction (Z) which decreases going from the first end (14a) to the second end (14b), and the insert (4) presenting first and second portions at said first and second ends (14a, 14b).

3/ An antivibration support according to claim 2, in which the first portion of the insert (4) is a raised rim (27) perpendicular to the longitudinal direction (Y) of the lateral guides, the second portion (4) being an edge (28) opposite said rim (27).

4/ An antivibration support (1) according to claim 2 or claim 3, in which the insert (4) comes into abutment against the second ends (14b) of the lateral guides (14).

5/ An antivibration support according to claim 1, in which each of the lateral guides (14) has first and second ends (14a, 14b), the first ends (14a) of the two lateral guides (14) being spaced apart by a distance (L) greater than the distance (l) between the second ends (14b) of the two lateral guides (14).

6/ An antivibration support according to claim 5, in which the insert (4) and the lateral guides (14) are shaped in such a manner that the insert (4) is wedged in the lateral guides (14) without play in a second direction (X) perpendicular to the first direction (Y) and to the main vibration direction (Z).

7/ An antivibration support according to claim 6, in which the insert (4) has two edges, each of which extends parallel to a respective bearing surface (36) when the insert is in place on the first strength member (2).

8/ An antivibration support (1) according to any one of claims 2 to 7, in which the abutment zone comprises a punching (29) made in the first strength member (2) and forming a projection of material at the first end (14a) of at least one of the lateral guides.

9/ An antivibration support according to any preceding claim, in which each lateral guide (14) has a lip (30) covering the insert (4) in part, and the abutment zone comprises at least one pressed-down zone (30a) of the lip of the lateral guide (14) pressed against the insert (4).

10/ An antivibration support according to any preceding claim, in which the abutment zone comprises at least one folded-down portion (32, 33) of the insert (4), said portion being folded down against an edge belonging to the first strength member (2).

11/ An antivibration support according to any preceding claim, having at least one layer of elastomer interposed between the insert (4) and the first strength member (2).

12/ An antivibration support according to any preceding claim, in which the insert (4) is a stamped metal sheet having a central portion that is substantially frustoconical on which the elastomer body (6) is overmolded.

13/ A method of manufacturing an antivibration support according to any preceding claim, the method comprising the following steps:
molding the elastomer body (6) between the insert (4) and the second strength member (3);
after unmolding, engaging the insert (4) in the lateral guides (14) until said insert (4) becomes wedged in the lateral guides; and
making said abutment (29, 30a, 32, 33) to prevent the insert (4) from moving relative to said first strength member (2), thereby preventing said insert (4) from escaping from the lateral guides (14).
